(19) United States
(12) Patent Application Publication
(10) Pub. No.: US 2006/0027492 A1
(43) Pub. Date: Feb. 9, 2006

(54) Filter mechanism

(76) Inventor: Mao Chang Lin, Taichung Hsien (TW)

Correspondence Address: Mao Chang Lin, 235 Chung - Ho, Box 8-24, Taipei, TW

(21) Appl. No.: 10/912,689

(22) Filed: Aug. 6, 2004

(51) Int. Cl. B01D 29/58

(52) U.S. Cl. 210/338; 210/315; 210/443; 210/497.01; 210/451

(57) ABSTRACT

A filter mechanism comprises a plurality of coaxially arranged filter rolls each having a multitude of uniformly distributed filtering pores for retaining impurity particles in water, when it is mounted within a water filter. The filter rolls are made of a selected antirust material and therefore can be cleaned and reused once the filtering effect is deteriorating, so that the cost of maintenance and the pollution to the environment can be significantly reduced.

### FIELD OF THE INVENTION

The present invention relates to water filters, more particularly to a filter mechanism having a plurality of cylindrical filter layers (filter rolls), each provided with a multitude of filtering pores. The filter mechanism can be installed in a water filter for retaining impurity particles and thereby upgrade water quality. The cylindrical filter layers are made of a selected antirust material and can be cleaned and recycled when the filtering effect is deteriorating, therefore reducing the cost of maintenance and waste to the environment.

### BACKGROUND OF THE INVENTION

Water filter utilizes various filtering materials to filter out the impurity particles in water, and a user can select a filtering material or a combination of filtering materials to achieve a desired water quality.

The filtering materials of the prior art, such as PP foam and sponge cloth, are not reusable. Therefore, when the filtering effect is deteriorating, the filtering material has to be replaced, which causes pollution problem to the environment. Further, since the conventional filtering materials cannot be recycled, the maintenance cost for a water filter is high.

### SUMMARY OF THE INVENTION

Accordingly, the primary objective of the present invention is to provide a recyclable filter mechanism so that the cost of maintenance and the pollution to the environment can be significantly reduced.

To achieve the above objective, the filter mechanism comprises a plurality of coaxial filter rolls each having a multitude of filtering pores for retaining impurity particles in water, when it is mounted within a water filter. The filter rolls are made of antirust materials and therefore can be cleaned and reused once the filtering effect is deteriorating.

To achieve above object, the present invention provide a filter mechanism, which comprises a plurality of coaxially arranged filter rolls at a predetermined spacing with each other, each of said filter rolls having a multitude of uniformly distributed filtering pores for retaining impurity particles in water; a mount connected to a bottom end of the outmost one of said filter rolls for retaining the inner ones of said filter rolls, said mount being provided with a bottom axial retaining hole at the center thereof for connecting a retaining piece on a bottom of a water filter; and a lid attached onto a top end of said outmost one of said filter rolls, said lid being provided with a top axial retaining hole at the center thereof, an annular groove being formed around said top axial retaining hole having a water-proof washer installed therein, whereby said filter rolls can be dismounted once said lid is removed, whereby said annular groove can be used to couple with a rim of a water outlet tube on a top inner wall of said filter container when said filter mechanism is installed within said filter container. A top lid of said filter container can press against said lid of said filter rolls and thereby reinforce said filter mechanism against high pressure water when said top lid is mounted on said filter container.

The various objects and advantages of the present invention will be more readily understood from the following detailed description when read in conjunction with the appended drawings.

### BRIEF DESCRIPTION OF THE DRAWINGS

FIG. 1 is a perspective view of the first preferred embodiment of the present invention as a filter mechanism.

FIG. 2 is a lateral cross-sectional view of the filter mechanism according to the present invention in FIG. 1.

FIG. 3 is a local cross-sectional view of the mount of the second preferred embodiment of the present invention.

FIG. 4 is a cross-sectional view of the mount of the third preferred embodiment of the present invention.

FIG. 5 is a cross-sectional view of a filter mechanism according to the present invention in the filter container of a water filter.

FIG. 6 is a cross sectional view of the present invention.

### DETAILED DESCRIPTION OF THE PREFERRED EMBODIMENTS

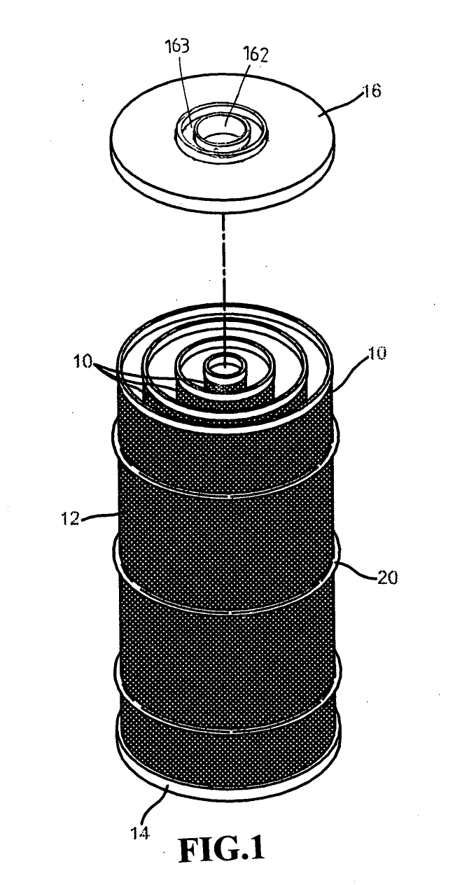

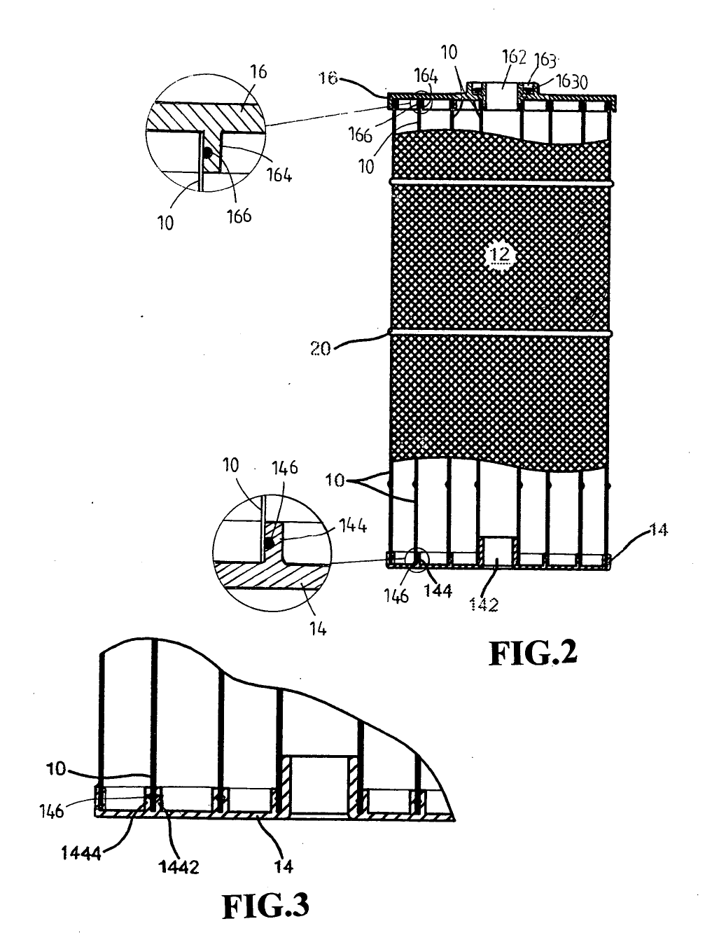

Referring to FIGS. 1 and 2, a preferred embodiment as a filter mechanism according to the present invention can be designed to fit into filter containers of a variety of water filters so as to upgrade water quality. Nevertheless, it can also be used with air filters to upgrade air quality. The filter mechanism comprises a plurality of coaxial filter rolls 10 made of antirust materials selected from stainless steel, plastic and other suitable materials. The lateral wall of each of the filter rolls 10 is distributed with a multitude of filtering pores 12. The outmost one of the filter rolls 10 is provided with a mount 14 at the bottom end thereof so that others of the filter rolls 10 can be secured thereon. At the top end of the outmost one of the filter rolls 10 a separable lid 16 is provided for sealing the inner ones of the filter rolls 10 within the outmost one of the filter rolls 10. To change the inner ones of the filter rolls 10, simply remove the lid 16. The central axis of the mount 14 is further provided with an axial hole 142 for a later use of mounting the filter mechanism.

Thereby, the filter mechanism just disclosed consists of a multiple layers of filter rolls 10, and the filtering pores 12 thereon have a selected size that is different over the filter rolls 10, depending on the choice of filtering paths.

Each of the filter rolls 10 can be a seamless hollow cylinder formed by say die-casting, or if can be formed by rolling up a piece of suitable material and connecting two lateral sides. In the latter case, at least two securing rings 20 are installed to enclose the cylinder at one end and in a middle portion.

As shown in FIG. 2, the filter mechanism having a plurality of filter rolls 10 is mounted on the bottom side of a filter container, with the axial hole 142 of the mount 14 mounted on a retaining post within the filter container. Thereby, the impurity particles of in the water passing through the filter container can be retained in the container. The mount 14 at one end of the outmost filter roll is further provided with retaining projections 144, and the rims of each of the filter rolls 10 can be engaged with the retaining projections 144, either on the inner or the outer rims thereof, achieving a retaining effect of the filter rolls 10 on the mount 14. To avoid unwanted water infiltration through the seams between the filter rolls 10 and the retaining projections 144, at least a water-proof washer 146 is provided at each interface between a filter roll and a retaining projection.

As shown in FIG. 3, to provide a better retaining effect for the filter rolls 10 situating on the mount 14, the inner wall of the mount 14 can be provided with a plurality of pairs of an inner retaining projection 1442 and an outer projection 1444 so that each of the filter rolls 10 is retained from both sides of the bottom rim thereof. It is obvious that a water-proof washer 146 can be provided on the inner sides or/and the outer sides of each interface of the filter rolls 10 and the mount 14. The filter rolls 10 can each be integrally formed with a mount 14, therefore each of the filter rolls 10 having a mount 14. The central portions of these mounts 14 are respectively provided with an axial retaining hole 142. Each of the mounts 14 of the filter rolls 10 is provided with a retaining projection so that the mount 14 of a middle size filter roll 10 can be overlapped and retained on the mount 14 of a large size filter roll 10, and the mount 14 of a small size filter roll 10 can be overlapped and retained on the mount 14 of a medium size filter roll 10. If the number of filter rolls 10 is more than three, the smaller the filter roll 10 the upper level its mount 14 is stacked.

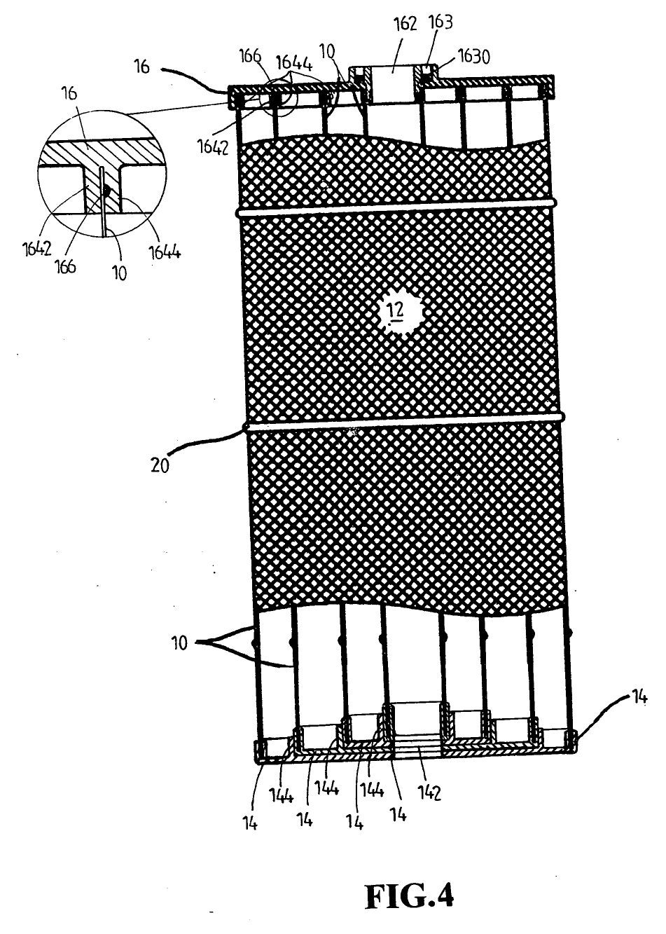

Referring to FIG. 4, the lid 16 is used, after all the filter rolls 10 are mounted properly, to seal upon the other ends of the filter rolls 10. The means for connecting the lid 16 with the filter rolls 10 is similar to that of the mount 14 and the filter rolls 10, having a plurality of retaining projections 164 or pairs of inner and outer retaining projections 1642, 1644 formed on the inner face of the lid 16. The interfaces of the lid 16 and each of the filter rolls 10 can be further provided with a water-proof washer 166, and the center of the lid 16 can be further provided with an axial retaining hole 162. On the outer face of the lid 16, there is a circular groove 163 formed around the axial retaining hole 162 and a water-proof washer 1630 installed within the groove 163.

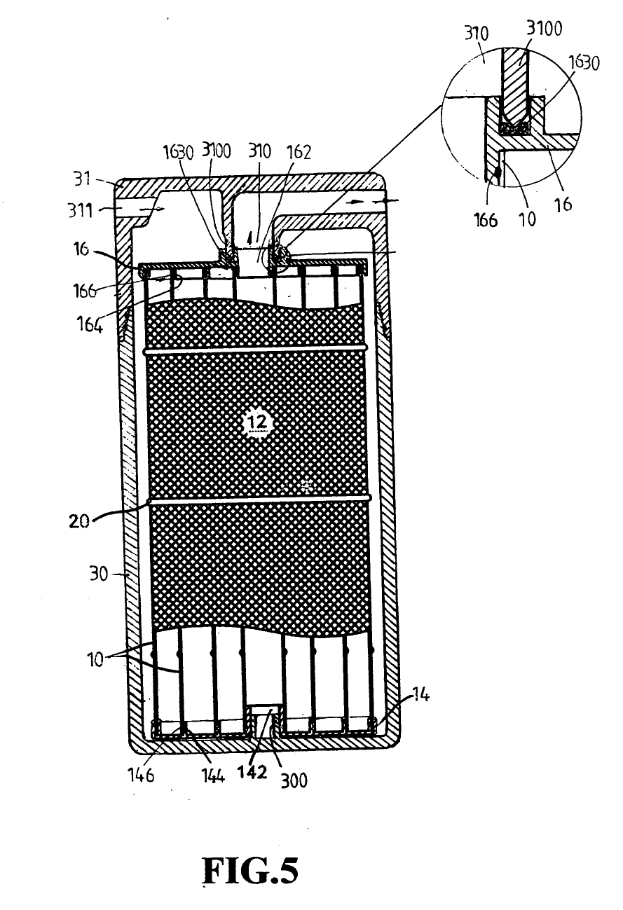

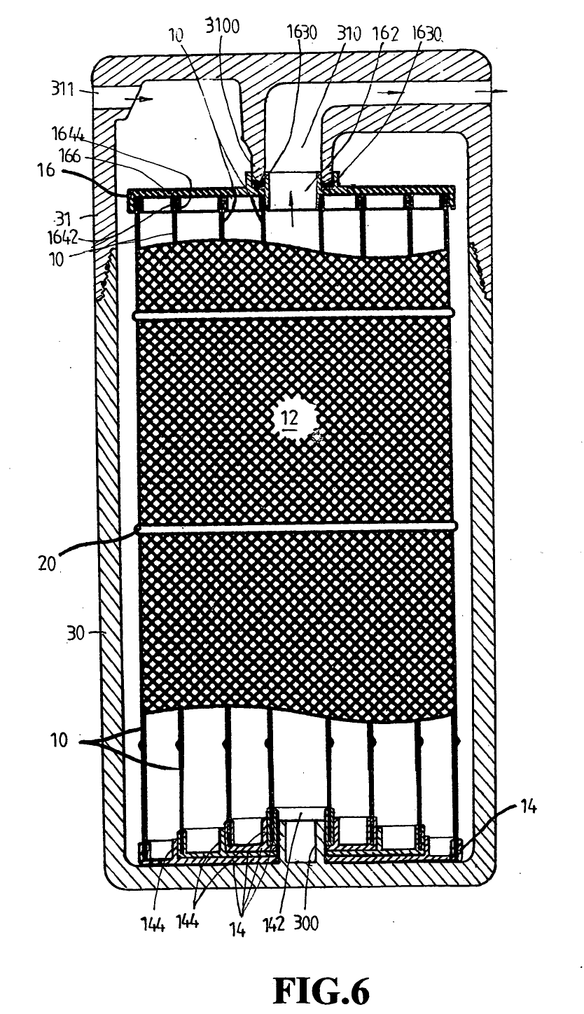

Referring to FIG. 5 and 6, as the filter mechanism is installed in a filter container 30 of a water filter, the axial retaining hole 142 is mounted on a retaining rod 300 on the inner bottom wall of the filter container 30, and the outer rim of a water outlet 3 10 on the inner face of a filter container lid 31 is engaged within the axial retaining hole 162 on the lid 16. As the container lid 31 is screwed tight around the top of the filter container 30, the outer rim of a water outlet 310 is pressed against the water-proof washer 1630 so that water flowing through the interface will not leak. At the same time, the lid 16 of the filter rolls 10 is pressed down to engage even tighter with the filter rolls 10, thereby water of high hydraulic pressure will not push the lid open. Water is flown at a water inlet 311 on the container lid 31, penetrating from outer filter rolls 10 into inner filter rolls 10, whereby the water is filtered by the pores 12. Processed water is then flown along the innermost filter roll to the axial retaining hole 162 on the lid 16, and then the water outlet 310 of the filter container lid 31.

Since the filter rolls 10 are made of antirust materials, they can be cleaned by water and other suitable solvents and reused, when the filtering effect is deteriorating, therefore reducing the cost of maintenance and waste to the environment.

The present invention is thus described, and it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A filter mechanism, comprising:
a plurality of coaxially arranged filter rolls at a predetermined spacing with each other, each of said filter rolls having a multitude of uniformly distributed filtering pores for retaining impurity particles in water;
a mount connected to a bottom end of the outmost one of said filter rolls for retaining the inner ones of said filter rolls, said mount being provided with a bottom axial retaining hole at the center thereof for connecting a retaining piece on a bottom of a water filter; and
a lid attached onto a top end of said outmost one of said filter rolls, said lid being provided with a top axial retaining hole at the center thereof, an annular groove being formed around said top axial retaining hole having a water-proof washer installed therein, whereby said filter rolls can be dismounted once said lid is removed, whereby said annular groove can be used to couple with a rim of a water outlet tube on a top inner wall of said filter container when said filter mechanism is installed within said filter container;
whereby as a top lid of said filter container presses against said lid of said filter rolls, said filter mechanism is reinforced to resist against high pressure water when said top lid is mounted on said filter container.

2. The filter mechanism of claim 1 wherein the respective sizes of said filtering pores on said filter rolls are different, arranged from big to small either inwardly or outwardly.

3. The filter mechanism of claim 1 wherein said mount is provided with a plurality of retaining projections for retaining a bottom end of each of said inner ones of said filter rolls.

4. The filter mechanism of claim 3 wherein each of said retaining projections is further provided at least one water-proof washer.

5. The filter mechanism of claim 3 wherein said mount is further provided with a second set of retaining projections so that said bottom ends of said filter rolls can be held from both of the inward direction and the outward direction.

6. The filter mechanism of claim 1 wherein each of said filter rolls is formed by scrolling a piece of material and connecting two lateral sides of said material to form a hollow cylinder.

7. The filter mechanism of claim 6 wherein said scrolled material is further encircled by a plurality of retaining rings at least around a top end and a middle portion of each of said filter rolls.

8. A filter mechanism, comprising:
a plurality of coaxially arranged filter rolls at a predetermined spacing with each other, each of said filter rolls having a multitude of uniformly distributed filtering pores;
a plurality of mounts respectively integrally formed at said bottom ends of said filter rolls, each of said mounts being provided with a retaining projection for retaining the next smaller mount thereon except for the innermost one of said filter rolls, each of said mounts being provided with a bottom axial retaining hole at the center thereof, whereby said filter rolls can be coaxially arranged and secured by stacking said mounts from the largest to the smallest upwardly and coupling said retaining projections of various sizes; and
a lid attached onto a top end of said outmost one of said filter rolls, said lid being provided with a top axial retaining hole at the center thereof, an annular groove being formed around said top axial retaining hole having a water-proof washer installed therein, whereby said filter rolls can be dismounted once said lid is removed, whereby said annular groove can be used to couple with a rim of a water outlet tube on a top inner wall of a filter container when said filter mechanism is installed within said filter container;
whereby a top lid of said filter container can press against said lid of said filter rolls and thereby reinforce said filter mechanism against high pressure water when said top lid is mounted on said filter container.

9. The filter mechanism of claim 1, wherein the filter mechanism is made of a selected antirust material.
